(19) United States
(12) Patent Application Publication
(10) Pub. No.: US 2008/0071699 A1
(43) Pub. Date: Mar. 20, 2008

(54) Family of Size Based Indices and Funds

(76) Inventor: Michael Luke Catalano-Johnson, Malvern, PA (US)

Correspondence Address: FISH & RICHARDSON P.C., P.O. BOX 1022, MINNEAPOLIS, MN, 55440-1022, US

(21) Appl. No.: 11/533,299

(22) Filed: Sep. 19, 2006

(51) Int. Cl. G06Q 40/00

(52) U.S. Cl. 705/36 R

(57) ABSTRACT

A method for creating or maintaining a family of size based indices or funds includes selecting a list of M companies, assigning a raw share quantity to each company, and determining a rank i for each company based on size of the company. The method includes determining rank thresholds and creating or maintaining a family of indices or funds.

### TECHNICAL FIELD

This invention relates to financial instruments, and more particularly to a family of size based indices.

### BACKGROUND

As used herein, the term “financial instruments” includes securities, commodities and any other financial instruments created, developed or otherwise derived from an index or fund, including without limitation, exchange traded funds, options (including, but not limited to, options on any index or fund), futures, and swaps.

Many index or fund benchmarks are used as passive investment tools by funds, institutional investors and individuals who own the underlying financial instruments in the same weights as the benchmark.

Some indices or funds intend to track particular market-capitalization segments of the market (e.g., large-cap, small-cap, etc.). Over time, the sizes of the companies change either due to price fluctuations or other corporate actions. Consequently, the index or fund may wish to reconstitute its portfolio to more accurately reflect the current make-up of companies in a size segment. On a periodic basis (e.g., yearly, quarterly, monthly), companies generally are re-ranked by the size measure and a “new” index or fund replaces the “old” index or fund. Companies in the old index or fund which are not in the new index or fund are sometimes called “deletions,” while companies in the new index or fund which are not in the “old” index or fund are sometimes called “additions.” The remaining financial instruments in the portfolio may experience re-weightings due to the additions and deletions.

These additions and deletions (and sometimes the re-weightings) create liquidity events in their respective financial instruments. A financial instrument that must be purchased or sold in a large quantity at a specific time (e.g., on the close of the day of the reconstitution) by those tracking the index or fund may see its price increase or decrease, respectively, as passive portfolios adjust their holdings accordingly.

Indices or funds have attempted in the past to mitigate the liquidity effects of such rebalances in various types. One way is the creation of explicit or de facto “buffer-zones” whereby companies generally stay in the index or fund for a time, such as one yearly rebalance, provided that the company's size has not grown or decreased by too great of a factor in that time. However, such buffer-zone techniques may still create unusual liquidity effects when securities are eventually added to or deleted from the index or fund. In addition, the index or fund methodology's rules may make it possible for some financial instruments to continue to be included in an index or fund for a period when they are no longer representative of the market-capitalization segment their index or fund is meant to track.

### SUMMARY

In one aspect of the invention, a method of creating or maintaining a family of size based indices or funds is provided. The method includes selecting a list of companies M, assigning a raw share quantity to each company, and determining a rank i for each company. The method also includes determining rank thresholds T₁ . . . T_{N-1}, where N indicates the number of indices or funds in the family. A family of indices or funds I₁ . . . I_{N} is created, where I₁ targets companies with size rank≦T₁, Iⱼ targets companies with size rank>Tⱼ₋₁ and ≦Tⱼ, where j is between 2 and N−1, and I_{N} targets companies whose size rank is >T_{N-1}. The step of creating or maintaining the family of indices or funds includes: for each 1≦j≦N, choosing a function fⱼ: {1, 2, . . . M}→[0,1] so that the equation f₁(i)+f₂(i)+ . . . f_{N}(i)=1 is satisfied for all i; and creating or maintaining the family of size based indices or funds in accordance with the formula: IS_{j,i}=fⱼ(i)×RSᵢ, where IS_{j,i} represents index or fund shares for size rank i in index j, and RSᵢ denotes the raw share quantity for a security of a company with size rank i.

In another aspect of invention, a family of size based indices or funds is created or maintained in accordance with the method described in the previous paragraph.

In another aspect of the invention, a fund or family of funds or an index or family of indices may be constituted utilizing methods of the invention. Moreover, a marketplace may comprise one or more funds or indices constituted according to a method of the invention.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a chart showing a set of weight adjustment functions.

FIG. 2 is a schematic diagram of a computer system.

### DETAILED DESCRIPTION

The present invention relates to the creation or maintenance of indices or funds comprised of financial instruments.

The method set forth herein substantially eliminates the sharp liquidity events associated with additions and deletions to an index or fund. With the application of the methodology, as the size of a company increases or decreases, the fraction of the company's financial instruments owned by people or entities passively tracking that index or fund gradually decreases until it exits from the support of that index or fund.

The method also enables indices or funds to more closely track companies in their size segment. When some companies stray outside of the “core” of their size segment, the index or fund adjusts automatically to discount the weight of those companies, focusing more on the core of the index or fund, rather than waiting for the financial instrument to be deleted.

On a periodic basis, including, but not limited to, annually, quarterly, monthly or daily, a family of size based indices or funds is created or maintained. The term “create” is used for purposes of convenience, not limitation, and includes forming, devising, developing, making, producing or any other similar action.

A family of size based indices or funds may be comprised of financial instruments. In one embodiment, a family of size based indices or funds is comprised of shares of companies, as will be more fully explained herein.

A list of companies M is selected from a plurality of companies. As used herein, the terms “select” and “determine” are for purposes of convenience, not limitation, and are understood to include selecting, electing, choosing, picking or any other similar action. The list of companies may be defined in any suitable manner, for example, by the countries in which they are incorporated or registered, the exchange on which their securities trade, the business in which they are engaged, or any other attribute(s) or a combination of the foregoing.

As commonly understood, a “share” may refer to a single unit of a financial instrument. A share generally has a price associated with it. The index or fund methodology determines the amount of shares, or “share quantities,” for the financial instruments to be included in the index. As a non-limiting example, an index or fund may consist of 3 stocks, ABC, XYZ, and QRST, having respective share quantities of 2, 5, and 17. In this scenario, the index or fund value would equal 2 times the price of ABC plus 5 times the value of XYZ plus 17 times the value of QRST. The share quantities are usually fixed to achieve a desired type of weighting (equal dollar weighting, price weighting, market capitalization weighting, etc.). The term “raw share” or “raw shares” is used to differentiate the share quantities used to establish a desired weighting before constitution or re-constitution of an index or fund according to the invention. It is understood that the terms “constitution” and “re-constitution” are utilized for convenience only, and that either term may be utilized to connote the formation or maintenance of an index or fund.

After the list of companies M is selected, a raw share quantity is assigned to each company. The raw share quantities are chosen to achieve the desired weighting of financial instruments in the index or fund. As a non-limiting example, a market capitalization weighted index or fund could use the number of outstanding shares of a company as the raw share quantity and a float-adjusted market-capitalization weighted index or fund could use the number of free-float shares as the raw share quantity. These raw share quantities may be subsequently adjusted to yield the number of shares assigned to each financial instruments in each of the indices or funds in the family.

After assigning a raw share quantity to each company, a rank i is determined for each company.

The companies may be ranked according to some measure of size. A rank of 1 may indicate the largest size, with successive integers being assigned to companies of smaller size. Alternatively, a rank of 1 could indicate the smallest size. For example, the measure of size could be based on market capitalization, float-adjusted market capitalization, total revenue, enterprise value, or any other category or combinations thereof.

Rank thresholds 0=T₀<T₁<T₂<T₃< . . . <T_{N-1}<T_{N}=M are determined, where N indicates the number of indices or funds in the family. Let RSᵢ denote the raw share quantity for the financial instrument of a company with rank i.

In this description, a size based index or fund is one that tracks the financial instruments of companies in a specific range of sizes, as explained above. A family of size based indices or funds is a set of such indices or funds, each of which tracks a different range of sizes.

For example, suppose that threshold values are given and a family of indices or funds is to be created, where each index or funds in the family targets those companies whose size is between two of these thresholds. Two indices or funds in this family may target sets of financial instruments that are disjoint, in the case where both defining thresholds of one index or fund are below the thresholds defining the other, or they may overlap, in the case where the upper threshold for the index or fund targeting smaller size companies is greater than the lower threshold for the index or fund targeting larger size companies.

In this exemplary method, full generality is allowed for indices or funds in the family for every combination of lower threshold and upper threshold among the thresholds. Not all indices or funds thus created need to be used as the basis for calculated market indices or funds or traded products for the benefits of the method to be achieved.

Suppose the rank thresholds are 0=T₀<T₁<T₂<T₃< . . . <T_{N-1}<T_{N}=M and a size based family of indices or funds Iⱼ_{₁}_{,j}_{₂} (for 0≦j₁<j₂≦N) is to be created, where Iⱼ_{₁}_{,j}_{₂} targets companies with size rank>Tⱼ_{₁} and size rank≦Tⱼ_{₂}, respectively.

For each 1≦j≦N, choose a function fⱼ: {1, 2, . . . , M}→[0,1] so that the equation

f₁(i)+f₂(i)+ . . . f_{N}(i)=1

is satisfied for all i. The quantity fⱼ(i) is the proportion of the raw share quantity of company i to be used in index or fund I_{i,j+1}. In some applications fⱼ(i)=0 for i outside of the interval between Tⱼ₋₁ and Tⱼ. The value of fⱼ(i) may be referred to as the “smooth transitions weight adjustment factor” for a financial instrument with size rank i in index or fund Iⱼ₋₁ⱼ.

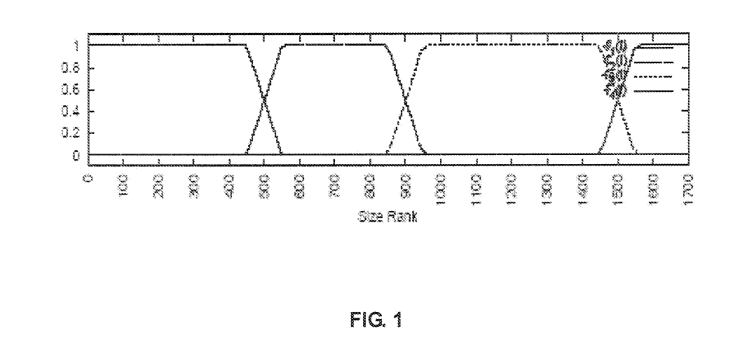

FIG. 1 shows graphs of a set of smooth transition weight adjustment functions. The set of i for which fⱼ(i)>0 and for which fⱼ(i)<0 is called the “support” of fⱼ and the j^{th} size-based index I_{j-1,j}. The set of i for which fⱼ(i)=1 is referred to as the “core” of the index I_{j-1,j}, and the set of i for which fⱼ(i) is strictly between 0 and 1 is called the “buffer-zone” of the index I_{j-1,j}. Note that the support of an index is the union of the two non-overlapping parts, the “core” and the “buffer-zone.”

Next, the index shares ISⱼ_{₁}_{,j}_{₂} (i) of company with size-rank i in index or fund Iⱼ_{₁}_{,j}_{₂} are set by the expression:

$${IS}_{{j}_{1} , {j}_{2}} ( i ) = ( {\sum }_{j = {j}_{1} + 1}^{{j}_{2}} {f}_{j} ( i ) ) \times {RS}_{i}$$

These ISⱼ_{₁}_{,j}_{₂} determine the portfolios of the re-constituted family of indices or funds. Note that with this definition, indices I_{0,1} I_{1,2} I_{2,3} . . . I_{N-1,N} form a family with disjoint cores such that the sum of the index or fund shares in each of these indices or funds is equal to the raw share quantity initially selected. The method further avoids double counting of companies across the separate indices or funds in the set I_{0,1}, I_{1,2}, I_{2,3}, . . . , I_{N-1,N}. Because the values of the f-functions sum to 1 for each financial instrument in the list of financial instruments, the shares of the company are distributed among the indices or funds of this set so that its weight is divided proportionally across the different indices or funds in the family. This mirrors the blurred consensus of where size segments begin and end and avoids double counting the size of indices or funds in multiple indices or funds.

As a non-limiting example of creating a family of market-capitalization based indices or funds, suppose an index or fund targeting the top 100 companies by market-capitalization whose stocks trade on the NASDAQ National Market System (NMS) is desired. In this scenario, T₁=100, and T₂ equals the number of companies trading on the NMS at the time of index or fund constitution. Choose a function f₁ such that

f₁(i)=1.0 1≦i≦100

f₁(i)=(150−i)/50 101≦i≦150

f₁(i)=0.0 151≦i

and the function f₂ so that f₂(i)=1.0−f₁(i). In this example, the range 1≦i≦100 constitutes the core of the index or fund, 101≦i≦150 the buffer, and 1≦i≦150 is the support. The number 150 is optionally chosen, and may be selected as any useful value.

In addition, the method is easily amenable to the formation of style and sector based sub-indices or sub-funds. The methodology allows index or fund providers to create sub-indices or sub-funds based on other (non-size based) criteria such as investment style or industrial classification. Given a hard categorization of financial instruments in the size based index or fund (i.e., in the support of the index or fund, respectively), the share amounts for the category based indices or funds are equal or substantially equal to the share amounts for the company in the index or fund. More generally, if the categorization of the financial instruments as to style or sector is not a hard assignment but rather divides the weight of the financial instruments up among the categories (p₁ in category 1, . . . p_{C} in category C), then the index or fund shares for company i in the k^{th} category subindex of index Iⱼ_{₁}_{,j}_{₂} can be defined to be:

ISⱼ_{₁}_{,j}_{₂}_{,k}(i)=pₖ×ISⱼ_{₁}_{,j}_{₂}(i)

It is understood that each of these advantages is exemplary and no such advantage or feature should be construed as a limitation of the invention set forth in the claims.

In a further embodiment of the invention, the method described above may be utilized to select financial instruments that may constitute all or part of one or more funds or indices, including, but not limited to, an exchange traded fund (ETF). It is understood that the term “fund” or “index” used herein includes ETF's and the like, without limitation, as understood in the art. The method may, for example, be utilized to determine the initial constitution of a fund or index, and may also preferably be utilized to re-constitute or maintain the fund periodically.

As non-limiting examples, a fund or index based on a method of the invention may constitute exactly those securities within an index or fund created or maintained according to the invention. Alternatively, an index or fund created or maintained according to the invention may identify a subset of financial instruments within a fund or index; or a fund or index may constitute a subset of the financial instruments of an index or fund created or maintained according to the invention; or a combination of both.

A family of funds or indices may likewise be created in a like manner, utilizing one or more funds or indices constituted according to the invention.

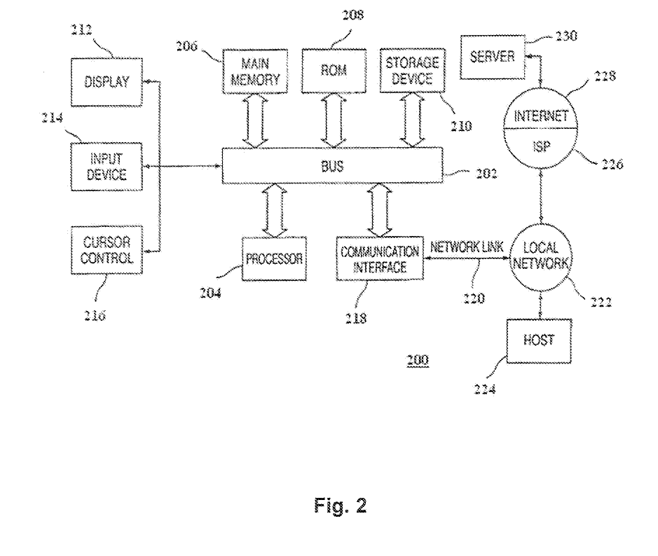

In a further embodiment, one or more funds, securities, futures or other financial instruments according to the invention may be traded on a marketplace for such financial instruments. It is understood that the term “marketplace” is construed broadly herein, to include (i) all U.S. and foreign exchanges, including without limitation, all organizations, associations or groups of persons, whether incorporated or unincorporated, that constitute, maintain or provide a marketplace or facilities for bringing together buyers and sellers of securities, futures and/or other financial instruments, for bringing together orders for securities, futures and/or other financial instruments of multiple buyers and sellers, or for otherwise performing with respect to securities, futures and/or other financial instruments the functions commonly performed by a stock exchange, commodity exchange, trading center, alternative trading system, trade reporting system, alternative display facility, automated trading center, electronic communications network or other similar facility as those terms are respectively generally understood; (ii) al U.S. and foreign quotation and trade reporting systems or any other similar facilities or market centers where orders to buy and sell securities, futures, and/or other financial instruments interact with each other; (iii) all, and all market facilities maintained by any such, exchanges, quotation systems, trading centers, alternative trading systems, alternative display facilities, automated trading centers, electronic communications networks or other facilities; and (iv) all U.S. and foreign over-the-counter markets, including, without limitation, all in-person, telephone, computer or other electronic networks that connect buyers and sellers of securities, futures and/or other financial instruments. A marketplace may constitute an exchange, quotation system, alternative trading system, trading center, automatic trading system, electronic communications network or other marketplace on which one or more funds, securities, futures or other financial instruments according to the invention are traded. FIG. 2 illustrates an exemplary system, such as a computer system, on which the methodology described herein can be utilized. One suitable computer system upon which the method may be implemented is shown at 200. Computer system 200 includes a bus 202 or other communication mechanism for communicating information, and a processor 204 coupled with bus 202 for processing information. Computer system 200 also includes a main memory 206, such as a random access memory (RAM) or other dynamic storage device, coupled to bus 202 for storing information and instructions to be executed by processor 204. Main memory 206 also may be used for storing temporary variable or other intermediate information during execution of instructions to be executed by processor 204. Computer system 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions.

Computer system 200 may be coupled via bus 202 to a display 212, such as a cathode ray tube (CRT), for displaying information to a computer user. An input device 214, which may include alphanumeric and other keys, is coupled to bus 202 for communicating information and command selections to processor 204. Another type of user input device is cursor control 216, such as a mouse, a trackball, or cursor direction keys for communicating direction information and command selections to processor 204 and for controlling cursor movement on display 212. This input device typically has two degrees of freedom in two axes, a first axis (e.g., x) and a second axis (e.g., y), that allows the device to specify positions in a plane.

According to one embodiment, computer system 200 operates in response to processor 204 executing one or more sequences of one or more instructions contained in main memory 206. Such instructions may be read into main memory 206 from another computer-readable medium, such as storage device 210. Execution of the sequences of instructions contained in main memory 206 causes processor 204 to perform the process steps described herein. One or more processors in a multi-processing arrangement may also be employed to execute the sequences of instructions contained in main memory 206. In alternative embodiments, hard-wired circuitry may be used in place of or in combination with software instructions to implement the methodology. Thus, practicing the methodology are not limited to any specific combination of hardware circuitry and software, and the description here and below is understood to be an exemplary embodiment of a system of the invention.

A software application containing coding for implementing the process described herein can be stored or reside in any suitable computer-readable medium. The term “computer-readable medium” as used herein refers to any medium that participates in providing instructions to processor 204 for execution. Such a medium may take many forms, including, but not limited to, non-volatile media, volatile media, and transmission media. Non-volatile media include, for example, optical or magnetic disks, such as storage device 210. Volatile media include dynamic memory, such as main memory 206. Transmission media include coaxial cables, copper wire, and fiber optics, including the wires that comprise bus 202. Transmission media can also take the form of acoustic or light waves, such as those generated during radio frequency (RF) and infrared (IR) data communications. Common forms of computer-readable media include, for example, floppy disk, a flexible disk, hard disk, magnetic tape, and other magnetic medium, a CD-ROM, DVD, any other optical medium, punch cards, paper tape, any other physical medium with patterns of holes, a RAM, a PROM, an EPROM, a FLASHEPROM, any other memory chip or cartridge, a carrier wave as described hereinafter, or any other medium from which a computer can read.

Various forms of computer-readable media may be involved in carrying one or more sequences of one or more instructions to processor 204 for execution. For example, the instructions may initially be borne on a magnetic disk of a remote computer. The remote computer can load the instructions into its dynamic memory and send the instructions over a telephone line using a modem. A modem local to computer system 200 can receive the data on the telephone line and use an infrared transmitter to convert the data to an infrared signal. An infrared detector coupled to bus 202 can receive the data carried in the infrared signal and place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 may be an integrated services digital network (ISDN) card or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic, or optical signals that carry digital data streams representing various type of information.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the worldwide packet data communication network, now commonly referred to as the “Internet” 228. Local network 222 and Internet 228 both use electrical, electromagnetic, or optical signals that carry digital data streams. The signals through the various networks and the signals on network line 220 and through communication interface 218, which carry the digital data to and from computer system 200, are exemplary forms of carrier waves transporting the information.

Computer system 200 can send messages and receive data, including program codes, through the network(s), network line 220, and communication interface 218. In the Internet example, a server 230 might transmit a requested code for an application program through Internet 228, ISP 226, local network 222, and communication interface 218.

The received code may be executed by processor 204 as it is received, and/or stored in storage device 210, or other non-volatile storage for later execution. In this manner, computer system 200 may obtain an application code in the form of a carrier wave.

It is understood that the above described computer system has been presented for the purposes of illustration and description only, and any number of alternative computer based implementations can be readily devised by one of ordinary skill in the art, and are suitable for practicing and implementing the invention.

A number of embodiments of the invention have been described. Nevertheless, it will be understood that various modifications may be made without departing from the spirit and scope of the invention. For example, although the example set forth above refers to NASDAQ, any marketplace can be used. Accordingly, other embodiments are within the scope of the following claims.

What is claimed is:

1. A method of creating or maintaining a family of size based indices or funds comprising:
selecting a list of companies M,
assigning a new share quantity to each company;
determining a rank i for each company based on size of the company;
determining N+1 rank thresholds 0=T₀<T₁< . . . <T_{N-1}<T_{N}=M;
creating or maintaining a family of indices or funds Iⱼ_{₁}_{,j}_{₂} (0≦j₁<j₂≦N) where Iⱼ_{ᵢ}_{,j}₂ targets companies with size rank>Tⱼ_{₁} and size rank≦Tⱼ_{₂}
wherein the step of creating or maintaining the family of indices or funds includes:
for each 1≦j≦N, choosing a function fⱼ: {1, 2, . . . M}→[0,1] so that the equation f₁(i)+f₂(i)+ . . . f_{N}(i)=1 is satisfied for all i; and
creating or maintaining the family of size based indices or funds in accordance with the formula:
$${IS}_{{j}_{1} , {j}_{2}} ( i ) = ( {\sum }_{j = {j}_{1} + 1}^{{j}_{2}} {f}_{j} ( i ) ) \times {RS}_{i} , where$$
ISⱼ_{₁}_{,j}_{₂}(i) represents index or fund shares for the financial instrument with size rank i in index or fund Iⱼ_{₁}_{,j}_{₂},
RSᵢ denotes raw share quantity for a financial instrument of a company with size rank i.

2. The method of claim 1, wherein a lower rank i denotes greater raw share quantity.

3. The method of claim 1, wherein the family of size based indices or funds comprises an index or fund, respectively, of one.

4. The method of claim 1, further comprising trading the family on a marketplace.

5. The method of claim 4, wherein the marketplace comprises at least one item selected from the group consisting of an exchange, a quotation and trade reporting system, a market facility, and an over-the-counter market.

6. The method of claim 4, wherein the marketplace comprises at least one item selected from the group consisting of an exchange, quotation system, alternative trading system, trading center, automatic trading system, and an electronic communications network.

7. The method of claim 1, wherein the financial instrument comprises stock.

8. A family of size based indices or funds created or maintained by:
selecting a list of companies M;
assigning a raw share quantity to each company;
determining a rank i for each company based on size of the company;
determining N+1 rank thresholds 0=T₀<T₁< . . . <T_{N-1}<T_{N}=M;
creating or maintaining a family of indices of funds Iⱼ_{₁}_{,j}_{₂} (0≦j₁<j₂=N) where Iⱼ_{₁}_{,j}_{₂} targets companies with size rank>Tⱼ_{₁} and size rank≦Tⱼ_{₂}
wherein the step of creating or maintaining the family of indices or funds includes:
for each 1≦j≦N, choosing a function f₁: {1, 2, . . . M}→[0,1] so that the equation f₁(i)+f₂(i)+ . . . f_{N}(i)=1 is satisfied for all i; and
creating or maintaining the family of size based indices or funds in accordance with the formula:
$${IS}_{{j}_{1} , {j}_{2}} ( i ) = ( {\sum }_{j = {j}_{1} + 1}^{{j}_{2}} {f}_{j} ( i ) ) \times {RS}_{i} , where$$
ISⱼ_{₁}_{,j}_{₂} (i) represents index or fund shares for the financial instrument with size rank i in index ISⱼ_{₁}_{,j}_{₂} (i), and
RSᵢ denotes raw share quantity for a financial instrument of a company with size rank i.

9. The family of size based indices or funds of claim 7, wherein the family comprises an index or fund of one.

10. The family of size based indices or funds of claim 7, further comprising trading the family on a marketplace.

11. The family of size based indices or funds of claim 10, wherein the marketplace comprises at least one item selected from the group consisting of an exchange, a quotation and trade reporting system, a market facility, and an over-the-counter market.

12. The family of size based indices or funds of claim 10, wherein the marketplace comprises at least one item selected from the group consisting of an exchange, quotation system, trading center, alternative trading system, automatic trading system, and an electronic communications network.

13. The method of claim 1, wherein the financial instrument comprises stock.

14. A family of size based indices or funds created or maintained by:
selecting a list of companies M;
assisting a raw share quantity to each company;
determining a rank i for each company based on size of the company;
determining a rank threshold T;
creating or maintaining a family of indices or funds I₁ . . . I_{N}, where N indicates a number of companies selected from the list of companies M and
I₁ targets companies with size rank≦T,
Iⱼ targets companies with size rank>Tⱼ₋₁ and ≦Tⱼ, for 2≦j≦N−1, and
I_{N} targets companies whose size rank is >T_{N-1},
wherein the step of creating or maintaining the family of indices or funds includes:
for each 1≦j≦N, choosing a function fⱼ: {1, 2, . . . , M}→[0,1] so that the equation f₁(i)+f₂(i)+ . . . f_{N}(i)=1 is satisfied for all i; and
creating or maintaining the family of size based indices or funds in accordance with the formula:
IS_{j,i}=fⱼ(i)×RSᵢ, where
IS_{j,i} represents index shares for size rank i in index j, and
RSᵢ denotes raw share quantity for a financial instrument of a company with size rank i.

15. The family of size based indices or funds of claim 14, wherein the family comprises an index or fund of one.

16. The family of size based indices or funds of claim 14, further comprising trading the family on a marketplace.

17. The family of size based indices or funds of claim 16, wherein the marketplace comprises at least one item selected from the group consisting of an exchange, a quotation and trade reporting system, a market facility, and an over-the counter market.

18. The family of size based indices or funds of claim 16, wherein the marketplace comprises at least one item selected from the group consisting of an exchange, quotation system, trading center, alternative trading system, automatic trading system, and an electronic communications network.

19. The family of size based indices or funds of claim 14, wherein the financial instrument comprises stock.

20. A method of creating or maintaining a family of size based indices or funds comprising:
selecting a list of companies M;
assigning a raw share quantity to each company;
determining a rank i for each company based on size of the company;
determining rank thresholds T₁ . . . T_{N-1}, where N indicates a number of companies selected from the list of companies M;
creating or maintaining a family of indices or fund I₁ . . . I_{N}, where
I₁ targets companies with size rank≦T₁,
Iⱼ targets companies with size rank>Tⱼ₋₁ and ≦Tⱼ, for 2≦j≦N−1, and
I_{N} targets companies whose size rank is >T_{N-1},
wherein the step of creating the family of indices or funds includes:
for each X≦j≦N, choosing a function fⱼ: {1, 2, . . . M}→[0,X] so that the equation f₁(i)+f₂(i)+ . . . f_{N}(i)=X is satisfied for all i, where X is a number representing raw share quantity; and
creating or maintaining the family of size based indices or funds in accordance with the formula:
IS_{j,i}=fⱼ(i)×RSᵢ, where
IS_{j,i} represents index or fund shares for size rank i in index j, and
RS₁ denotes raw share quantity for a financial instrument of a company with size rank i.

21. The method of claim 20, wherein a lower rank i denotes greater raw share quantity.

22. The method of claim 20, further comprising trading the family on a marketplace.

23. The method of claim 22, wherein the marketplace comprises at least one item selected from the group consisting of an exchange, a quotation and trade reporting system, a market facility, and an over-the-counter market.

24. The method of claim 23, wherein the marketplace comprises at least one item selected from the group consisting of an exchange, quotation system, trading center, alternative trading system, automatic trading system, and an electronic communications network.

25. The method of claim 20, wherein the financial instrument comprises stock.

26. The method of claim 20, wherein the family of size based indices or funds comprises an index of one.

27. A family of size based indices or funds created or maintained by:
selecting a list of companies M;
assigning a raw share quantity to each company;
determining a rank i for each company based on size of the company;
determining rank thresholds T₁ . . . T_{N-1}, where N indicates a number of companies selected from the list of companies M;
creating or maintaining indices or funds I₁ . . . I_{N}, where
I₁ targets companies with size rank≦T₁,
Iⱼ targets companies with size rank>Tⱼ₋₁ and ≦Tⱼ, for 2≦j≦N−1, and
I_{N} targets companies whose size rank is >T_{N-1},
wherein the step of creating the indices or funds includes:
for each X≦j≦N, choosing a function fⱼ: {1, 2, . . . , M}→[0,X] so that the equation f₁(i)+f₂(i)+ . . . f_{N}(i)=X is satisfied for all I, where X is a number representing a raw share quantity; and
creating or maintaining the indices or funds in accordance with the formula:
IS_{j,i}=fⱼ(i)×RS₁, where
IS_{j,i} represents index or fund shares for size rank i in index j, and
RSᵢ denotes raw share quantity for a financial instrument of a company with size rank i.

28. The family of size base indices or funds of claim 27, wherein the family comprises an index or fund of one.

29. The family of size based indices or funds of claim 27, wherein the financial instrument comprises stock.

30. A fund or index comprising a plurality of financial instruments, wherein the plurality of securities are selected by:
selecting a list of companies M;
assigning a raw share quantity to each company;
determining a rank i for each company based on size of the company;
determining N+1 rank thresholds 0=T₀<T₁< . . . <T_{N-1}<T_{N}=M;
creating or maintaining a family of indices or funds Iⱼ_{₁}_{,j}₂ (0≦j₁<j₂=N) where
Iⱼ_{₁}_{,j}_{₂} targets companies with size rank≧Tⱼ_{₁} and size rank<Tⱼ_{₂}; wherein the step of creating or maintaining the family of indices or funds includes:
for each 1≦j≦N, choosing a function fⱼ: {1, 2, . . . , M}→[0,1] so that the equation f₁(i)+f₂(i)+ . . . f_{N}(i)=1 is satisfied for all i; and
creating or maintaining the family of size based indices or funds in accordance with the formula:
$${IS}_{{j}_{1} , {j}_{2}} ( i ) = ( {\sum }_{j = {j}_{1} + 1}^{{j}_{2}} {f}_{j} ( i ) ) \times {RS}_{i} , where$$
ISⱼ_{₁}_{,j}_{₂} (i) represents index or fund shares for the financial instrument with size rank i in index or fund I_{j1,j2}, and
RSᵢ denotes raw share quantity for a financial instrument of a company with size rank I; and
assigning at least a portion of the financial instruments within one of the size based indices or fund to the index or fund.

31. The fund according to claim 30, wherein all of the financial instruments within one of the size based indices or funds are assigned to the index or fund.

32. The fund according to claim 30, wherein the financial instruments comprise stocks.

33. A plurality of indices or funds, each fund comprising a plurality of financial instruments, wherein the plurality of indices or funds are formed by:
selecting a list of companies M;
assigning a raw share quantity to each company;
determining a rank i for each company based on size of the company;
determining N+1 rank thresholds 0=T₀<T₁< . . . <T_{N-1}<T_{N}=M;
creating or maintaining a family of indices or funds Iⱼ_{₁}_{,j}_{₂} (0≦j₁<j₂<N) where
Iⱼ_{₁}_{,j}_{₂} targets companies with size rank≧Tⱼ_{₁} and size rank<Tⱼ_{₂}; wherein the step of creating or maintaining the family of indices or funds includes:
for each 1≦j≦N, choosing a function fⱼ: {1, 2, . . . M}→[0,1] so that the equation f₁(i)+f₂(i)+ . . . f_{N}(i)=1 is satisfied for all i; and
creating or maintaining the family of size based indices or funds in accordance with the formula:
$${IS}_{{j}_{1} , {j}_{2}} ( i ) = ( {\sum }_{j = {j}_{1} + 1}^{{j}_{2}} {f}_{j} ( i ) ) \times {RS}_{i} , where$$
ISⱼ_{₁}_{,j}_{₂} (i) represents index or fund shares for the financial instrument with size rank i in index or fund Iⱼ_{₁}_{,j}_{₂}, and
RSᵢ denotes raw share quantity for a financial instrument of a company with size rank I; and
assigning the financial instruments within each one of the size based indices or funds to the each one of the respective funds.

34. The plurality of indices or funds of claim 33, wherein the financial instruments comprise stocks.

35. A securities marketplace comprising at least one index or fund, the index or fund comprising a plurality of financial instruments, wherein the plurality of financial instruments are selected by:
selecting a list of companies M;
assigning a raw share quantity to each company;
determining a rank i for each company based on size of the company;
determining N+1 rank thresholds 0=T₀<T₁< . . . <T_{N-1}<T_{N}=M;
creating or maintaining a family of indices or funds Iⱼ_{₁}_{,j}_{₂} (0≦j₁<j₂=N) where
Iⱼ_{₁}_{,j}_{₂} targets companies with size rank≧Tⱼ_{ᵢ} and size rank<Tⱼ_{₂}; wherein the step of creating or maintaining the family of indices or funds includes:
for each 1≦j≦N, choosing a function fⱼ: {1, 2, . . . M}→[0,1] so that the equation f₁(i)+f₂(i)+ . . . f_{N}(i)=1 is satisfied for all i; and
creating or maintaining the family of size based indices or funds in accordance with the formula:
$${IS}_{{j}_{1} , {j}_{2}} ( i ) = ( {\sum }_{j = {j}_{1} + 1}^{{j}_{2}} {f}_{j} ( i ) ) \times {RS}_{i} , where$$
ISⱼ_{₁}_{,j}_{₂} (i) represents index or fund shares for the financial instrument with size rank i in index Iⱼ_{₁}_{,j}_{₂}, and
RSᵢ denotes raw share quantity for a financial instrument of a company with size rank I; and
assigning the financial instruments within one of the size based indices or funds to the index or fund.

36. The securities marketplace of claim 35, wherein the financial instruments comprise stock.

37. The securities marketplace of claim 35, wherein the marketplace comprises at least one item selected from the group consisting of an exchange, a quotation and trade reporting system, a market facility, and an over-the-counter market.

38. The securities marketplace of claim 35, wherein the marketplace comprises at least one item selected from the group consisting of an exchange, quotation system, trading center, alternative trading system, automatic trading system, and an electronic communications network.
